(19) United States
(12) Patent Application Publication
(10) Pub. No.: US 2022/0398682 A1
(43) Pub. Date: Dec. 15, 2022

(54) ANALYZING LEARNING CONTENT VIA AGENT PERFORMANCE METRICS

(71) Applicant: Genesys Cloud Services, Inc., Daly City, CA (US)

(72) Inventors: Wing Yee Tam, Markham (CA); Steve Gardner, Birmingham (GB); Reginald Cui, Markham (CA); Hongbo Liu, Markham (CA); Jae Yoon Cha, Markham (CA); Christopher Philip Cheel, Birmingham (GB)

(21) Appl. No.: 17/344,191

(22) Filed: Jun. 10, 2021

(51) Int. Cl. G06Q 50/20; G06Q 10/06; G06F 17/18

(52) U.S. Cl. CPC G06Q 50/2057; G06Q 10/06398; G06F 17/18; G06F 9/541

(57) ABSTRACT

A method of automated analysis of learning content's impact on agent performance according to an embodiment includes automatically determining a first set of performance metrics for an agent for a predefined first period before the agent participated in a learning module in response to notification of completion in the learning module, automatically determining a second set of performance metrics for the agent for a predefined second period after the agent participated in the learning module in response to determining that the predefined second period has elapsed, computing a first set of performance metric differences between those sets of metrics, and performing correlation analysis to determine whether the learning module significantly effects one or more performance metrics of the agent based on a plurality of performance metric differences computed for a plurality of agents, wherein the plurality of performance metric differences includes the first set of performance metric differences.

### BACKGROUND

Content centers and call centers have become ubiquitous in organizational structures, as communicating with agents and/or chat bots provide effective techniques for providing customer support and service. Some systems provide learning services or learning modules that the agents utilize in order to develop their skills. The learning modules may teach the agents a wide array of subjects ranging, for example, from substantive aspects of the respective business to the psychology of a caller and conflict resolution techniques. The potential topics available for agent consumption are limitless. However, training with learning modules consumes agent time, and organizations have inadequate techniques for confirming that a particular learning module is worth the time, often relying on intuition or anecdotal evidence.

### SUMMARY

One embodiment is directed to a unique system, components, and methods for automated analysis of learning content's impact on agent performance. Other embodiments are directed to apparatuses, systems, devices, hardware, methods, and combinations thereof for automated analysis of learning content's impact on agent performance.

According to an embodiment, a method of automated analysis of learning content's impact on agent performance may include automatically determining, by a computing system, a first set of performance metrics for an agent for a predefined first period before the agent participated in a learning module in response to notification of completion in the learning module, automatically determining, by the computing system, a second set of performance metrics for the agent for a predefined second period after the agent participated in the learning module in response to determining that the predefined second period has elapsed, computing, by the computing system, a first set of performance metric differences between the first set of performance metrics and the second set of performance metrics, and performing, by the computing system, correlation analysis to determine whether the learning module has a significant effect on one or more performance metrics of the agent based on a plurality of performance metric differences computed for a plurality of agents, wherein the plurality of performance metric differences includes the first set of performance metric differences.

In some embodiments, automatically determining the first set of performance metrics for the agent may include determining an agent identifier associated with the agent and a module identifier associated with the learning module, and the method may further include automatically determining, by the computing system, agent profile information associated with the agent.

In some embodiments, the agent profile information includes at least a hire date of the agent.

In some embodiments, determining that the predefined second period has elapsed may include determining that the predefined second period has elapsed in response to executing, by the computing system, a periodic analysis of a potential lapsing of post-learning periods for each agent that has completed a learning module.

In some embodiments, performing the correlation analysis may include executing a goodness of fit test to confirm that the performance metric differences constitute a normal distribution, and executing at least one of a paired t-test or a signed rank test to obtain a p-value and 95% confidence interval associated with the performance metric differences.

In some embodiments, performing the correlation analysis may include separating correlation analyses of agents based on at least one agent characteristic.

In some embodiments, the at least one agent characteristic may include at least one of work experience or work tenure.

In some embodiments, the method may further include providing correlation test results of the correlation analysis via an application programming interface of the computing system.

In some embodiments, providing the correlation test results may include providing a list of learning modules that improve a particular performance metric of agents.

In some embodiments, providing the correlation test results may include providing a list of learning modules that would improve one or more of a particular agent's performance metrics.

In some embodiments, providing the correlation test results may include providing a list of agents recommended to participate in a particular learning module.

In some embodiments, the first set of performance metrics may include at least two performance metrics selected from a call duration, a number of calls held, a number of calls transferred, a number of calls in which a second agent was consulted, a number of calls that were transferred as part of a consult, an amount of time spent in after call work, and an amount of time spent interacting.

According to another embodiment, a system for automated analysis of learning content's impact on agent performance may include at least one processor and at least one memory comprising a plurality of instructions stored thereon that, in response to execution by the at least one processor, causes the system to automatically determine a first set of performance metrics for an agent for a predefined first period before the agent participated in a learning module in response to notification of completion in the learning module, automatically determine a second set of performance metrics for the agent for a predefined second period after the agent participated in the learning module in response to a determination that the predefined second period has elapsed, compute a first set of performance metric differences between the first set of performance metrics and the second set of performance metrics, and perform correlation analysis to determine whether the learning module has a significant effect on one or more performance metrics of the agent based on a plurality of performance metric differences computed for a plurality of agents, wherein the plurality of performance metric differences includes the first set of performance metric differences.

In some embodiments, to automatically determine the first set of performance metrics for the agent may include to determine an agent identifier associated with the agent and a module identifier associated with the learning module, and the plurality of instructions may further cause the system to automatically determine agent profile information associated with the agent.

In some embodiments, the plurality of instructions may further cause the system to perform a periodic analysis of a potential lapsing of post-learning periods for each agent that has completed a learning module, and the determination that the predefined second period has elapsed may be based on an execution of the periodic analysis.

In some embodiments, to perform the correlation analysis may include to execute a goodness of fit test to confirm that the performance metric differences constitute a normal distribution and execute at least one of a paired t-test or a signed rank test to obtain a p-value and 95% confidence interval associated with the performance metric differences.

In some embodiments, to perform the correlation analysis may include to perform separate correlation analyses of agents based on at least one of work experience or work tenure.

In some embodiments, the plurality of instructions may further cause the system to provide correlation test results of the correlation analysis via an application programming interface of the system, and to provide the correlation test results may include to provide a list of learning modules that improve a particular performance metric of agents.

In some embodiments, the plurality of instructions may further cause the system to provide correlation test results of the correlation analysis via an application programming interface of the system, and to provide the correlation test results may include to provide a list of learning modules that would improve one or more of a particular agent's performance metrics.

In some embodiments, the plurality of instructions may further cause the system to provide correlation test results of the correlation analysis via an application programming interface of the system, and to provide the correlation test results may include to provide a list of agents recommended to participate in a particular learning module.

In some embodiments, the first set of performance metrics may include at least two performance metrics selected from a call duration, a number of calls held, a number of calls transferred, a number of calls in which a second agent was consulted, a number of calls that were transferred as part of a consult, an amount of time spent in after call work, and an amount of time spent interacting.

According to yet another embodiment, a method of automated analysis of learning content's impact on agent performance may include triggering, by a computing system, a plurality of completion events associated with corresponding completion of a learning module by a plurality of agents, automatically determining, by the computing system, a first set of performance metrics for each agent of the plurality of agents for a corresponding predefined first period before each corresponding agent of the plurality of agents participated in the learning module in response to each agent's respective completion of the learning module, automatically determining, by the computing system, a second set of performance metrics for each agent of the plurality of agents for a corresponding predefined second period after each corresponding agent of the plurality of agents participated in the learning module in response to a determination that the corresponding predefined second period has elapsed, computing, by the computing system, a set of performance metric differences between the first set of performance metrics and the second set of performance metrics, and performing, by the computing system, correlation analysis to determine whether the learning module has a significant effect on one or more performance metrics of the plurality of agents based on the set of performance metric differences.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for automated analysis of learning content's impact on agent performance;

FIG. 2 is a simplified block diagram of at least one embodiment of a high level architecture of the cloud-based system of FIG. 1;

FIG. 3 is a simplified block diagram of at least one embodiment of a computing system; and

FIGS. 4-5 are a simplified flow diagram of at least one embodiment of a method for automated analysis of learning content's impact on agent performance.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

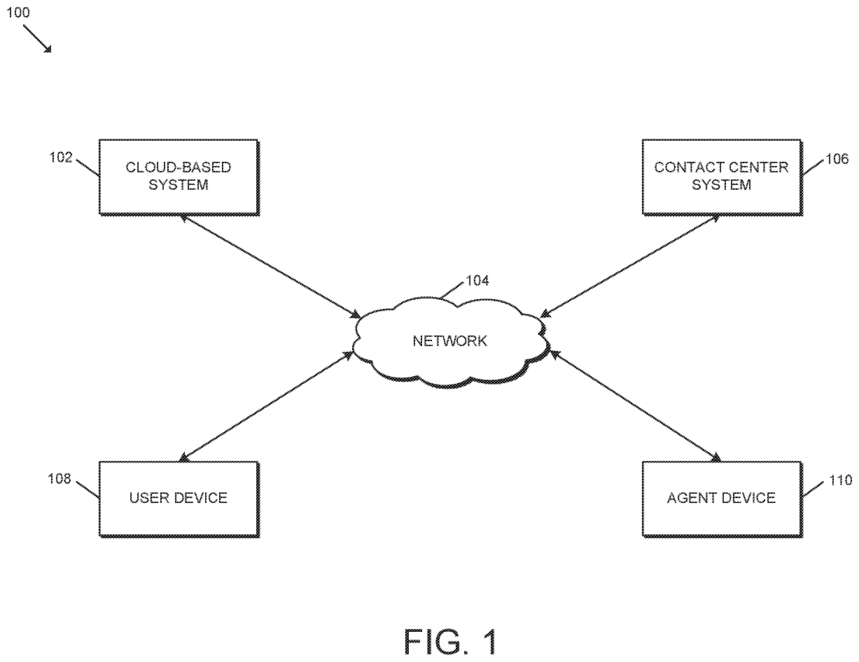

Referring now to FIG. 1, in the illustrative embodiment, a system 100 for automated analysis of learning content's impact on agent performance includes a cloud-based system 102, a network 104, a contact center system 106, a user device 108, and an agent device 110. Although only one cloud-based system 102, one network 104, one contact center system 106, one user device 108, and one agent device 110, are shown in the illustrative embodiment of FIG. 1, the system 100 may include multiple cloud-based systems 102, networks 104, contact center systems 106, user devices 108, and/or agent devices 110 in other embodiments. For example, in some embodiments, multiple cloud-based systems 102 (e.g., related or unrelated systems) may be used to perform the various functions described herein. Further, as described below, it should be appreciated that the cloud-based system 102 may analyze a large number of conversations between agents and users/customers conducted via the agent device 110 and the user device 108, respectively. In some embodiments, one or more of the systems described herein may be excluded from the system 100, one or more of the systems described as being independent may form a portion of another system, and/or one or more of the systems described as forming a portion of another system may be independent.

As described herein, it will be appreciated that the system 100 leverages an automated platform to provide insight into the effectiveness of particular learning modules at improving various performance metrics of agents, which may be used to determine the likely effectiveness of those learning modules for like-situated agents. In particular, in some embodiments, the cloud-based system 102 may analyze whether there is a correlation between having taken a learning module or coaching session and the agents' performance metrics, for example, by performing hypotheses testing. The system 100 may create a data pipeline that automatically performs the analysis periodically (e.g., nightly) for every learning module and agents who have taken the module, and stores the resultant data in a database in a manner that allows for easy retrieval via new application programming interfaces.

It should be appreciated that each of the cloud-based system 102, network 104, contact center system 106, user device 108, and agent device 110 may be embodied as any type of device/system, collection of devices/systems, or portion(s) thereof suitable for performing the functions described herein.

The cloud-based system 102 may be embodied as any one or more types of devices/systems capable of performing the functions described herein. For example, in the illustrative embodiment, the cloud-based system 102 is configured to retrieve learning completion events (e.g., from a message bus) indicating when agents have completed particular learning modules, and the cloud-based system 102 retrieves and stores performance metrics for the agents who just completed the learning modules associated with a pre-learning period (e.g., 10 days leading up to completion of the learning module). After a predefined post-learning period has elapsed (e.g., 10 days) from the completion of the learning module, the cloud-based system 102 retrieves and stores performance metrics for those agents for the post-learning period. The cloud-based system 102 analyzes the two sets of metrics to determine whether they are indicative of a significant improvement in the agents' performance metrics resulting from consumption of one or more of the learning modules. In some embodiments, the cloud-based system 102 may perform correlation analysis as described herein to do so. Further, the cloud- based system 102 provides various application programming interfaces (APIs) to allow a user to access various correlation test results as described below.

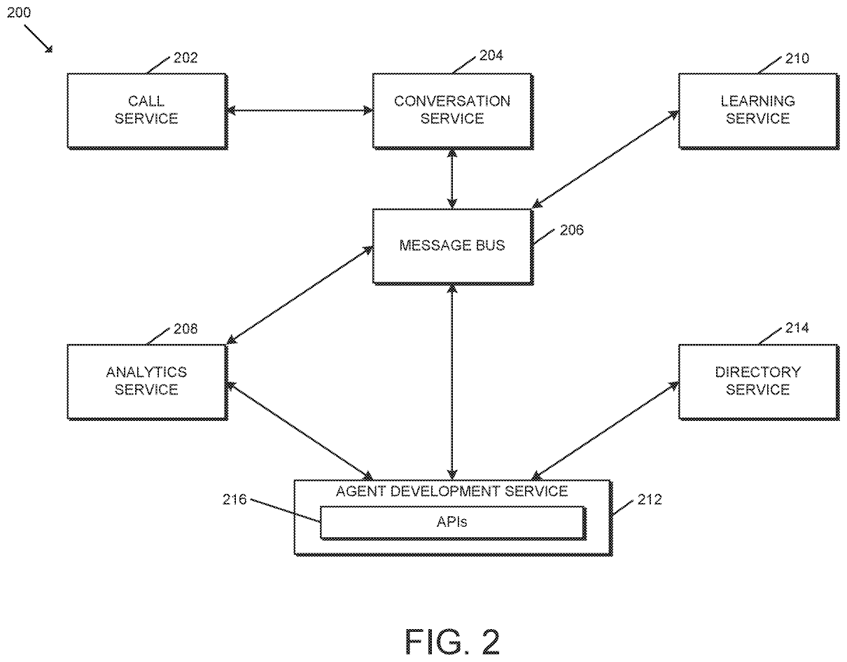

Although the cloud-based system 102 is described herein in the singular, it should be appreciated that the cloud-based system 102 may be embodied as or include multiple servers/systems in some embodiments. Further, although the cloud-based system 102 is described herein as a cloud-based system, it should be appreciated that the system 102 may be embodied as one or more servers/systems residing outside of a cloud computing environment in other embodiments. It should be appreciated that, in some embodiments, the cloud-based system 102 may include a system architecture similar to the high level architecture 200 described below in reference to FIG. 2.

In cloud-based embodiments, the cloud-based system 102 may be embodied as a server-ambiguous computing solution, for example, that executes a plurality of instructions on-demand, contains logic to execute instructions only when prompted by a particular activity/trigger, and does not consume computing resources when not in use. That is, system 102 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system 102 described herein. For example, when an event occurs (e.g., data is transferred to the system 102 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system 102), the appropriate virtual function(s) may be executed to perform the actions before eliminating the instance of the virtual function(s).

The network 104 may be embodied as any one or more types of communication networks that are capable of facilitating communication between the various devices communicatively connected via the network 104. As such, the network 104 may include one or more networks, routers, switches, access points, hubs, computers, and/or other intervening network devices. For example, the network 104 may be embodied as or otherwise include one or more cellular networks, telephone networks, local or wide area networks, publicly available global networks (e.g., the Internet), ad hoc networks, short-range communication links, or a combination thereof. In some embodiments, the network 104 may include a circuit-switched voice or data network, a packet-switched voice or data network, and/or any other network able to carry voice and/or data. In particular, in some embodiments, the network 104 may include Internet Protocol (IP)-based and/or asynchronous transfer mode (ATM)-based networks. In some embodiments, the network 104 may handle voice traffic (e.g., via a Voice over IP (VOIP) network), web traffic, and/or other network traffic depending on the particular embodiment and/or devices of the system 100 in communication with one another. In various embodiments, the network 104 may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. The network 104 may enable connections between the various devices/systems 102, 106, 108, 110 of the system 100. It should be appreciated that the various devices/systems 102, 106, 108, 110 may communicate with one another via different networks 104 depending on the source and/or destination devices/systems 102, 106, 108, 110.

In some embodiments, it should be appreciated that the cloud-based system 102 may be communicatively coupled to the contact center system 106, form a portion of the contact center system 106, and/or be otherwise used in conjunction with the contact center system 106. For example, the contact center system 106 may include a chat bot configured to communicate with a user (e.g., via the user device 108), or the contact center system 106 may facilitate a communication connection between an agent (e.g., via the agent device 110) and the user (e.g., via the user device 108). Further, in some embodiments, the user device 108 may communicate directly with the cloud-based system 102.

The contact center system 106 may be embodied as any system capable of providing contact center services (e.g., call center services) to an end user and otherwise performing the functions described herein. Depending on the particular embodiment, it should be appreciated that the contact center system 106 may be located on the premises/campus of the organization utilizing the contact center system 106 and/or located remotely relative to the organization (e.g., in a cloud-based computing environment). In some embodiments, a portion of the contact center system 106 may be located on the organization's premises/campus while other portions of the contact center system 106 are located remotely relative to the organization's premises/campus. As such, it should be appreciated that the contact center system 106 may be deployed in equipment dedicated to the organization or third-party service provider thereof and/or deployed in a remote computing environment such as, for example, a private or public cloud environment with infrastructure for supporting multiple contact centers for multiple enterprises. In some embodiments, the contact center system 106 includes resources (e.g., personnel, computers, and telecommunication equipment) to enable delivery of services via telephone and/or other communication mechanisms. Such services may include, for example, technical support, help desk support, emergency response, and/or other contact center services depending on the particular type of contact center.

The user device 108 may be embodied as any type of device capable of executing an application and otherwise performing the functions described herein. For example, in some embodiments, the user device 108 is configured to execute an application to participate in a conversation with a human agent, personal bot, automated agent, chat bot, or other automated system. As such, the user device 108 may have various input/output devices with which a user may interact to provide and receive audio, text, video, and/or other forms of data. It should be appreciated that the application may be embodied as any type of application suitable for performing the functions described herein. In particular, in some embodiments, the application may be embodied as a mobile application (e.g., a smartphone application), a cloud-based application, a web application, a thin-client application, and/or another type of application. For example, in some embodiments, application may serve as a client-side interface (e.g., via a web browser) for a web-based application or service. In other embodiments, it should be appreciated that the user may telephonically communicate with an agent via the user device 108. For brevity of the description, it should be further appreciated that calls referenced herein as telephonic may be embodied as or include voice-based communication technologies other than traditional telephony (e.g., VoIP).

The agent device 110 may be embodied as any type of device capable of executing an application and otherwise performing the functions described herein. For example, in some embodiments, the agent device 110 is configured to execute an application to allow the human agent to communicate with a user. Otherwise, it should be appreciated that the agent device 110 may be similar to the user device 108 described above, the description of which is not repeated for brevity of the description.

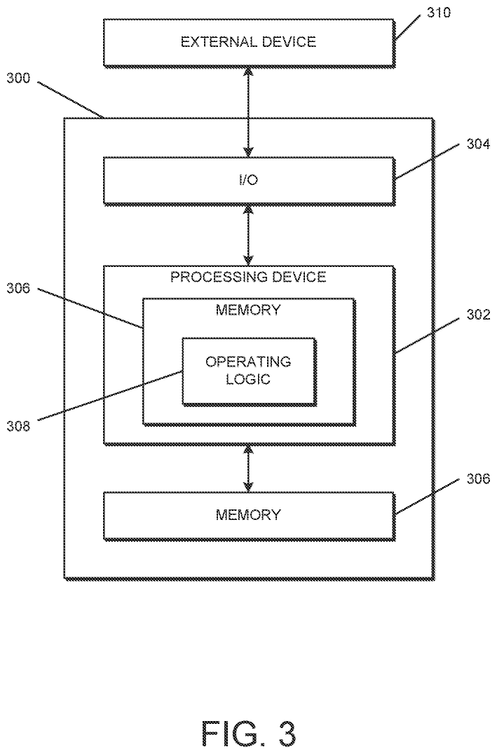

It should be appreciated that each of the cloud-based system 102, the network 104, the contact center system 106, the user device 108, and/or the agent device 110 may be embodied as (and/or include) one or more computing devices similar to the computing device 300 described below in reference to FIG. 3. For example, in the illustrative embodiment, each of the cloud-based system 102, the network 104, the contact center system 106, the user device 108, and/or the agent device 110 may include a processing device 302 and a memory 306 having stored thereon operating logic 308 (e.g., a plurality of instructions) for execution by the processing device 302 for operation of the corresponding device.

Referring now to FIG. 2, a simplified block diagram of at least one embodiment of a high level architecture 200 of the cloud-based system 102 is shown. The illustrative cloud- based system 102 includes a call service 202, a conversation service 204, a message bus 206, an analytics service 208, a learning service 210, an agent development service 212, and a directory service 214. Additionally, as shown in FIG. 2, the agent development service 212 may include a set of APIs 216 that allow for users of the cloud-based system 102 to retrieve various results described herein. Although only one call service 202, one conversation service 204, one message bus 206, one analytics service 208, one learning service 210, one agent development service 212, and one directory service 214 are shown in the illustrative embodiment of FIG. 2, the high level architecture 200 may include multiple call services 202, conversation services 204, message buses 206, analytics services 208, learning services 210, agent development services 212, and/or directory services 214 in other embodiments. Further, in some embodiments, one or more of the components described herein may be excluded from the architecture 200, one or more of the components described as being independent may form a portion of another component, and/or one or more of the component described as forming a portion of another component may be independent.

Each of the call service 202, the conversation service 204, the message bus 206, the analytics service 208, the learning service 210, the agent development service 212, and the directory service 214 may be embodied as, include, or form a portion of any one or more types of devices/systems that are capable of performing the functions described herein. In some embodiments, it should be appreciated that one or more of the call service 202, the conversation service 204, the message bus 206, the analytics service 208, the learning service 210, the agent development service 212, and the directory service 214 comprises a virtual component/service within a cloud computing environment.

The call service 202 handles calls and/or other communication sessions between agents and users. The call service 202 collects various data associated with the calls, such as temporally-related aspects of the calls, the occurrence of various events in or in association with the calls, and/or other relevant metrics associated with the calls. It should be appreciated that such data may constitute or form a portion of the performance metrics of a particular agent. Depending on the particular embodiment, the call service 202 may be native to the high level architecture 200 and/or the cloud-based system 102, or the call service 202 may be handled by another system integrated with or communicatively coupled with the high level architecture 200 and/or the cloud-based system 102.

Upon completion of the call, the call service 202 publishes various call-related data to the conversation service 204, which after capturing the information in turn publishes the data to the message bus 206. It should be appreciated that the message bus 206 may be embodied as any type of message bus capable of transferring data between the various components/services of the high level architecture 200 described herein. For example, in some embodiments, the message bus 206 may be embodied as an Apache Kafka message bus or other stream-processing message bus.

The analytics service 208 is embodied as a reporting service or engine for the high level architecture 200. Accordingly, the analytics service 208 consumes and analyzes data published to the message bus 206. In the illustrative embodiment, the analytics service 208 consumes conversation completion events associated with particular agents completing learning modules, and the analytics service 208 stores the relevant data to a data store, aggregates relevant data, and performs various calculations on the data. For example, in some embodiments, the analytics service 208 may calculate various sums, differences, means, minimums, maximums, and/or other statistical measures associated with the data.

The learning service 210 handles the learning modules described herein. In some embodiments, the learning service 210 allows an administrator to create course content and/or other learning content that agents can participate in to learn, for example, the best practices for serving customers. In other words, in some embodiments, the learning service 210 provides an eLearning platform for the training of contact center agents. Although the description focuses on such learning modules, it should be appreciated that, in some embodiments, the agents may also participate in coaching sessions. In such embodiments, the coaching sessions may be handled by the learning service 210 and/or another module of the high level architecture 200 depending on the particular embodiment. When an agent completes a learning module (or coaching session), the learning service 210 publishes an event to the message bus 206 to indicate that the agent has completed that particular module.

The agent development service 212 consumes the learning completion events and makes a request to the analytics service 208 to obtain performance metrics associated with the agents for the pre-learning period as described herein (e.g., 10 days leading up to completion of the learning module). In the illustrative embodiment, the agent development service 212 also executes a periodic job (e.g., nightly) to determine if a predefined post-learning period has passed since an agent completed a learning module (e.g., 10 days following completion of the learning module). If so, the agent development service 212 transmits another request to the analytics service 208 to obtain updated performance metrics associated with the agents for which the post-learning period has elapsed. The agent development service 212 further analyzes the two sets of performance metrics for the various agents and learning modules completed to determine which, if any, of the learning modules have improved one or more performance metrics of the agents or a subclass of agents. As described herein, the agent development service 212 may leverage various correlation analysis techniques to make such a determination. The agent development service 212 stores the various data including, for example, intermediate results, statistical measures, p-values, confidence intervals, and/or other relevant data in a data store or database for subsequent query via one or more APIs 216 of the agent development service 212.

The directory service 214 may be called by the agent development service 212 to retrieve agent profile information of the various agents that completed a learning module. In some embodiments, the agent profile information includes one or more characteristics of the agent such as, for example, the hire date of the agent, an indication of work experience of the agent, an indication of work tenure of the agent, and/or other relevant characteristics of the agent. As described below, it should be appreciated that the agent development service 212 may utilize the agent profile information to segment or separate the correlation analyses of the pre-learning and post-learning performance metrics of the agents into different agent groups based on one or more of the characteristics of the agent.

The APIs 216 may be used by an external device (e.g., a client device) to access the correlation test results from the agent development service 212. For example, in some embodiments, the APIs 216 provide an interface for a user to request the full set (or partial set) of correlation test result data for a particular learning module based on user input identifying the particular learning module of interest. In some embodiments, the correlation test result data may be represented as JSON data; however, it should be appreciated the correlation test result data may be otherwise represented in other embodiments. In some embodiments, the APIs 216 may also provide an interface for a user to request a list of learning modules that would improve a particular performance metric of agents or a subclass of agents based on user input identifying the particular performance metric of interest. In some embodiments, the APIs 216 may provide an interface for a user to request a list of learning modules that would improve one or more of a particular agent's performance metrics based on user input identifying the particular agent (e.g., via an agent identifier). In some embodiments, the APIs 216 may provide an interface for a user to request a list of agents recommended to particular in a particular learning module based on user input identifying the particular learning module of interest. It should be appreciated, however, that the agent development service 212 may include additional or alternative APIs 216 in other embodiments. It should be appreciated that the “lists” may be represented in any suitable format for performing the functions described herein and therefore are not limited to a particular structure or organization of data. Further, in some embodiments, it should be appreciated that the APIs 216 and/or other component(s) of the architecture 200 and/or the system 102 may automatically assign learning modules to various agents based on a determination that participation in the corresponding learning module(s) would improve one or more of the corresponding agent's performance metrics.

Referring now to FIG. 3, a simplified block diagram of at least one embodiment of a computing device 300 is shown. The illustrative computing device 300 depicts at least one embodiment of a cloud-based system, contact center system, user device, and/or agent device that may be utilized in connection with the cloud-based system 102, the contact center system 106, the user device 108, and/or the agent device 110 (and/or a portion thereof) illustrated in FIG. 1. Depending on the particular embodiment, the computing device 300 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 300 includes a processing device 302 that executes algorithms and/or processes data in accordance with operating logic 308, an input/output device 304 that enables communication between the computing device 300 and one or more external devices 310, and memory 306 which stores, for example, data received from the external device 310 via the input/output device 304.

The input/output device 304 allows the computing device 300 to communicate with the external device 310. For example, the input/output device 304 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 300 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 300. The input/output device 304 may include hardware, software, and/or firmware suitable for performing the techniques described herein.

The external device 310 may be any type of device that allows data to be inputted or outputted from the computing device 300. For example, in various embodiments, the external device 310 may be embodied as the cloud-based system 102, the contact center system 106, the user device 108, and/or a portion thereof. Further, in some embodiments, the external device 310 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 310 may be integrated into the computing device 300.

The processing device 302 may be embodied as any type of processor(s) capable of performing the functions described herein. In particular, the processing device 302 may be embodied as one or more single or multi-core processors, microcontrollers, or other processor or processing/controlling circuits. For example, in some embodiments, the processing device 302 may include or be embodied as an arithmetic logic unit (ALU), central processing unit (CPU), digital signal processor (DSP), and/or another suitable processor(s). The processing device 302 may be a programmable type, a dedicated hardwired state machine, or a combination thereof. Processing devices 302 with multiple processing units may utilize distributed, pipelined, and/or parallel processing in various embodiments. Further, the processing device 302 may be dedicated to performance of just the operations described herein, or may be utilized in one or more additional applications. In the illustrative embodiment, the processing device 302 is programmable and executes algorithms and/or processes data in accordance with operating logic 308 as defined by programming instructions (such as software or firmware) stored in memory 306. Additionally or alternatively, the operating logic 308 for processing device 302 may be at least partially defined by hardwired logic or other hardware. Further, the processing device 302 may include one or more components of any type suitable to process the signals received from input/output device 304 or from other components or devices and to provide desired output signals. Such components may include digital circuitry, analog circuitry, or a combination thereof.

The memory 306 may be of one or more types of non-transitory computer-readable media, such as a solid-state memory, electromagnetic memory, optical memory, or a combination thereof. Furthermore, the memory 306 may be volatile and/or nonvolatile and, in some embodiments, some or all of the memory 306 may be of a portable type, such as a disk, tape, memory stick, cartridge, and/or other suitable portable memory. In operation, the memory 306 may store various data and software used during operation of the computing device 300 such as operating systems, applications, programs, libraries, and drivers. It should be appreciated that the memory 306 may store data that is manipulated by the operating logic 308 of processing device 302, such as, for example, data representative of signals received from and/or sent to the input/output device 304 in addition to or in lieu of storing programming instructions defining operating logic 308. As shown in FIG. 3, the memory 306 may be included with the processing device 302 and/or coupled to the processing device 302 depending on the particular embodiment. For example, in some embodiments, the processing device 302, the memory 306, and/or other components of the computing device 300 may form a portion of a system-on-a-chip (SoC) and be incorporated on a single integrated circuit chip.

In some embodiments, various components of the computing device 300 (e.g., the processing device 302 and the memory 306) may be communicatively coupled via an input/output subsystem, which may be embodied as circuitry and/or components to facilitate input/output operations with the processing device 302, the memory 306, and other components of the computing device 300. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 300 may include other or additional components, such as those commonly found in a typical computing device (e.g., various input/output devices and/or other components), in other embodiments. It should be further appreciated that one or more of the components of the computing device 300 described herein may be distributed across multiple computing devices. In other words, the techniques described herein may be employed by a computing system that includes one or more computing devices. Additionally, although only a single processing device 302, I/O device 304, and memory 306 are illustratively shown in FIG. 3, it should be appreciated that a particular computing device 300 may include multiple processing devices 302, I/O devices 304, and/or memories 306 in other embodiments. Further, in some embodiments, more than one external device 310 may be in communication with the computing device 300.

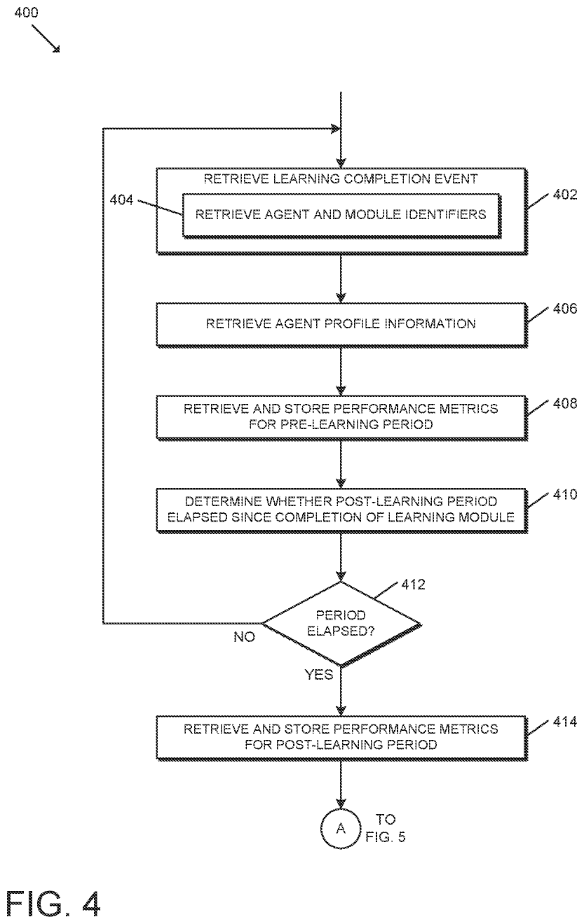

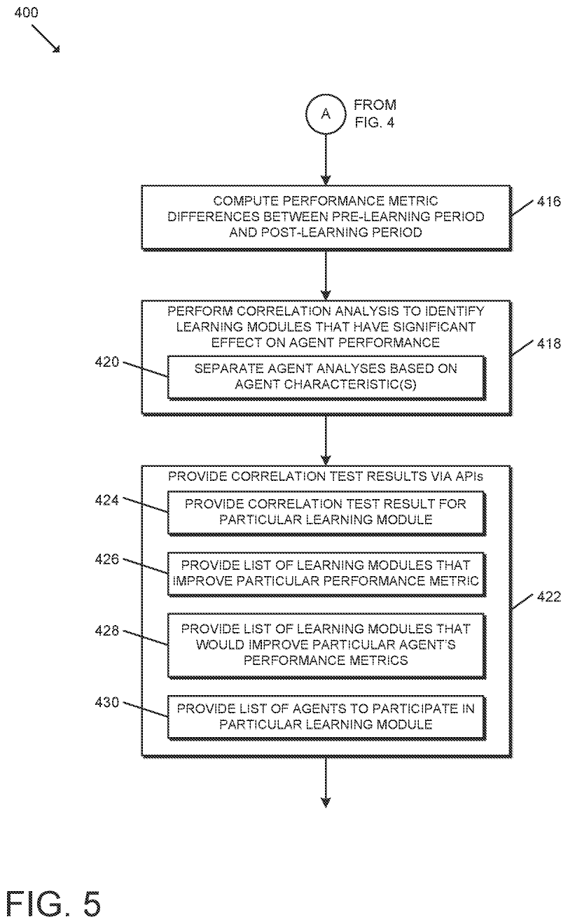

Referring now to FIGS. 4-5, in use, the system 100 (e.g., the cloud-based system 102) may execute a method 400 for automated analysis of learning content's impact on agent performance. It should be appreciated that the particular blocks of the method 400 are illustrated by way of example, and such blocks may be combined or divided, added or removed, and/or reordered in whole or in part depending on the particular embodiment, unless stated to the contrary.

The illustrative method 400 begins with block 402 of FIG. 4 in which the system 100 retrieves a learning completion event (e.g., from the message bus 206). In doing so, in block 404, the system 100 may retrieve an agent identifier associated with the particular agent that completed the learning module and a module identifier associated with the particular learning module that was completed. It should be appreciated that the agent identifier and/or the module identifier may be formatted in any way suitable for performing the functions described herein. In the illustrative embodiment, each agent identifier uniquely identifies a particular agent, and each module identifier uniquely identifies a particular learning module or coaching session.

In block 406, the system 100 retrieves agent profile information associated with the agent that completed the learning module, and therefore for which the particular learning completion event is associated. In some embodiments, the agent profile information may include one or more characteristics of the agent such as, for example, the hire date of the agent, an indication of work experience of the agent, an indication of work tenure of the agent, and/or other relevant characteristics of the agent. In particular, in some embodiments, the system 100 may use the agent's hire date to determine the agent's tenure at the particular organization. As described below, such information may be used to group agents for analysis according to tenure under the assumption that learning modules will have different effects on agents depending on how much experience those agents have. For example, in one implementation, the agents may be grouped into those having less than three months of experience (or 0-90 days since their respective hire dates), those with between three and six months of experience (or 91-180 days since their respective hire dates), those with more than six months of experience (or 181+ days since their respective hire dates), and those whose hire date and/or experience level is unknown. In some embodiments, the agent information may be retrieved via the directory service 214. It should be further appreciated that the agent profile information may include various other characteristics of the agent, which may be retrieved from the directory service 214 and/or another internal/external component of the system, and such data may be used to group the agents for analysis (e.g., correlation analysis) or for other purposes consistent with the technologies described herein.

In block 408, the system 100 retrieves and stores the agent's performance metrics for a pre-learning period associated with the agent's completion of the learning module and the publication of the learning completion event. In the illustrative embodiment, the pre-learning period is 10 days leading up to completion of the learning module (e.g., evidenced by the learning completion event). However, it should be appreciated that the pre-learning period may be another predefined period before completion of the learning module by the agent in other embodiments (e.g., 30 days). In some embodiments, the agent's performance metrics may be stored with, or stored in association with, pre-learning agent performance metrics for other agents who completed the same learning module (e.g., potentially separated by agent characteristics as described above). As such, the system 100 may obtain aggregate agent performance data associated with the pre-learning performance of agents who subsequently completed a particular learning module.

It should be appreciated that the particular agent performance metrics retrieved by the system 100 for the pre-learning period may vary depending on the particular embodiment. For example, in various embodiments, conversation metrics may include the number of interactions that were blind transferred, the number of connected co-browse sessions, the number of connected customer sessions, the number of interactions where an agent consulted another agent, the number of interactions that were transferred as part of a consult, the number of active sessions aborted due to an edge or adapter error event, the number of interactions offered to a queue by an Automatic Call Distributor (ACD), the number of outbound conversations placed on behalf of a queue, the number of outbound dialer calls that were abandoned, the number of outbound dialer calls attempted, the number of outbound dialer calls that connected, the number of answered interactions that were over the SLA threshold, the number of errors caused by clock skew, the number of interactions transferred (including blind transfers and consult transfers), the observed total media count for an external participant, the observed total media count for an internal participant (e.g., an agent), the service level for a queue, the service target for a queue, the amount of time before an end user abandoned an interaction in a queue, the amount of time spent waiting in queue before an interaction changed its state, the amount of time spent in after call work, the amount of time the use spent waiting for a response from the agent, the time an agent was being alerted, the amount of time an interaction waited to be connected to an agent, the time an agent spent on a callback while a call is active, the overall time an agent spent on a callback while calls are active, the time that it takes to establish a connection with a station on an outbound call, the time an agent spent dialing, the amount of time before an interaction was transferred out of a queue (and not answered by an agent), the complete time an agent spent on an interaction (including time spent contacting, time spent dialing, talk time, hold time, and after call work), the amount of time an interaction was placed on hold, the overall hold time for an interaction, the amount of time spent in IVR, the time spent monitoring an interaction, the time an agent was being alerted without responding to a queue conversation, the time an agent spent talking/interacting, the overall time an agent spent talking/interacting, the amount of time spent waiting for an end user response, the amount of time spent in voicemail, the amount of time spent waiting in queue before an interaction changed state, and/or other relevant conversation metrics. It should be appreciated that the agent performance metrics retrieved by the system for the pre-learning period (and/or the post-learning period described below) may include one or more of the conversation metrics identified above that are relevant to the performance of the agent. In other embodiments, it should be appreciated that additional and/or alternative agent performance metrics may be used by the system 100.

In block 410, the system 100 determines whether a post-learning period after the agent participated in the learning module (e.g., after the timestamp for the learning completion event) has elapsed. In the illustrative embodiment, the post-learning period is 10 days from the completion of the learning module (e.g., as evidenced by the learning completion event). However, it should be appreciated that the post-learning period may be another predefined period after completion of the learning module by the agent in other embodiments (e.g., 30 days). As described herein, it should be appreciated that the performance metrics of multiple agents may be analyzed in conjunction with one another. Accordingly, in some embodiments, the system 100 executes a periodic analysis of the potential lapsing of the post-learning periods for each agent that has completed a learning module to determine whether the corresponding post-learning period has elapsed for any of those instances. For example, in some embodiments, the system 100 may automatically run a nightly job to determine whether the post-learning period has elapsed since a corresponding completion of a learning module by an agent. It should be appreciated that the interval of the post-learning period may be the same as or different from the interval of the pre-learning period depending on the particular embodiment.

If the system 100 determines, in block 412, that the post-learning period has not elapsed (e.g., for any of the corresponding learning completion events), the method 400 returns to block 402 of FIG. 4 in which the system 100 retrieves another learning completion event for processing (e.g., upon publication of the learning completion event). However, if the system 100 determines, in block 412, that the post-learning period has elapsed for at least one corresponding learning event, the method 400 advances to block 414 in which the system 100 retrieves and stores the corresponding agent's performance metrics for the post-learning period (e.g., for each agent/module for which the post-learning period has elapsed). It should be appreciated that the particular agent performance metrics retrieved by the system 100 for the post-learning period may be the same types of performance metrics as retrieved for the pre-learning period. Accordingly, it should be appreciated that the agent performance metrics may be similar to those described above. Further, in some embodiments, the agent's post-learning performance metrics may be stored with, or stored in association with, post-learning agent performance metrics for other agents who completed the same learning module (e.g., potentially separated by agent characteristics as described above). As such, the system 100 may obtain aggregate agent performance data associated with the post-learning performance of agents who completed a particular learning module.

In block 416 of FIG. 6, the system 100 computes performance metric differences between the agent performance metrics for the pre-learning period and agent performance metrics for the post-learning period. For example, in some embodiments, the system 100 computes the percentage of calls/interactions that have a particular characteristic reflected by a metric for each of the pre-learning period and the post-learning period and calculate the percentage difference of the two percentages for that metric. In another embodiment, the system 100 computes the minimum, maximum, median, average, and/or other statistical measure of a particular characteristic of the calls/interactions reflected by a metric for each of the pre-learning period and the post-learning period and calculate the difference of the two values. Although the performance metric differences are described herein as “differences,” it should be appreciated that the computation of differences in the description is not limited to computing mathematical differences. Instead, in some embodiments, the performance metrics may be compared using other mathematical comparative techniques and/or algorithms.

In block 418, the system 100 performs correlation analysis to identify learning modules that have a significant effect on agent performance, for example, by significantly affecting one or more performance metrics of one or more groups of agents. In doing so, in block 420, the system 100 may perform separate correlation analyses for agents based on one or more agent characteristics as described above (e.g., based on the agents' tenure or work experience). It should be appreciated that the system 100 may perform correlation analysis of the performance metric differences described above (or otherwise based on the performance metrics) using any suitable techniques and/or algorithms. For example, in some embodiments, the system 100 executes a goodness of fit test to confirm that the performance metric differences constitute a normal distribution, and executes a paired t-test and/or a signed rank test to obtain a p-value and 95% confidence interval associated with the performance metric differences. It should be appreciated that the system 100 may be preconfigured with a notion of what constitutes a significant impact.

In the illustrative embodiment, the system 100 executes a correlation test for each learning module against each performance metric. In particular, for each learning module, the system 100 may split the agents into groups based on their respective hire dates as described above (e.g., 0-90 days, 91-180 days, 181+ days, unknown hire date), and for each group of agents, the system 100 may retrieve the average performance differences for the metrics. Further, the system 100 may run a goodness of fit test on the differences to confirm that it is a normal distribution. If so, the system 100 may run a paired t-test to obtain a p-value and 95% confidence interval (which could be configurable), and the system 100 may also run a Wilcoxon Signed-Rank test and log if there is a significant disagreement between p-values. If the distribution is not normal but the sample size is large (e.g., greater than 30), the system 100 may assume the effects of the Central Limit Theorem (CLT) and similarly calculate the p-value and 95% confidence interval, but log that the normality check failed and the CLT was relied upon. If the distribution is not normal and the sample is not large, the system 100 may run a Wilcoxon Signed-Rank test to obtain the p-value and confidence interval, and log that the normality check failed and CLT was not relied upon. It should be further appreciated that the agent performance data may be further sliced and/or analyzed based on agent characteristics and/or other parameters if there is sufficient data (e.g., by division, by queue, by performance metric percentile, etc.). In some embodiments, the agents may be divided into groups based on their respective performance percentile for particular agent performance metrics.

In block 422, the system 100 provides the correlation test results of the correlation analysis to users (e.g., client devices) via one or more APIs (e.g., the APIs 216 described above). For example, in block 424, the system 100 may provide, using a corresponding API, the full set (or partial set) of correlation test result data for a particular learning module based on user input identifying the particular learning module of interest. As described above, in some embodiments, the correlation test result data may be represented as JSON data; however, it should be appreciated the correlation test result data may be otherwise represented in other embodiments. In block 426, the system 100 may provide, using a corresponding API, a list of learning modules that would improve a particular performance metric of agents or a subclass of agents based on user input identifying the particular performance metric of interest. In block 428, the system 100 may provide, using a corresponding API, a list of learning modules that would improve one or more of a particular agent's performance metrics based on user input identifying the particular agent (e.g., via an agent identifier). In block 430, the system 100 may provide, via a corresponding API, a list of agents recommended to particular in a particular learning module based on user input identifying the particular learning module of interest. It should be appreciated, however, that the system 100 may include additional or alternative APIs in other embodiments.

What is claimed is:

1. A method of automated analysis of learning content's impact on agent performance, the method comprising:
automatically determining, by a computing system, a first set of performance metrics for an agent for a predefined first period before the agent participated in a learning module in response to notification of completion in the learning module;
automatically determining, by the computing system, a second set of performance metrics for the agent for a predefined second period after the agent participated in the learning module in response to determining that the predefined second period has elapsed;
computing, by the computing system, a first set of performance metric differences between the first set of performance metrics and the second set of performance metrics; and
performing, by the computing system, correlation analysis to determine whether the learning module has a significant effect on one or more performance metrics of the agent based on a plurality of performance metric differences computed for a plurality of agents, wherein the plurality of performance metric differences includes the first set of performance metric differences.

2. The method of claim 1, wherein automatically determining the first set of performance metrics for the agent comprises determining an agent identifier associated with the agent and a module identifier associated with the learning module; and
further comprising automatically determining, by the computing system, agent profile information associated with the agent.

3. The method of claim 2, wherein the agent profile information includes at least a hire date of the agent.

4. The method of claim 1, wherein determining that the predefined second period has elapsed comprises determining that the predefined second period has elapsed in response to executing, by the computing system, a periodic analysis of a potential lapsing of post-learning periods for each agent that has completed a learning module.

5. The method of claim 1, wherein performing the correlation analysis comprises:
executing a goodness of fit test to confirm that the performance metric differences constitute a normal distribution; and
executing at least one of a paired t-test or a signed rank test to obtain a p-value and 95% confidence interval associated with the performance metric differences.

6. The method of claim 1, wherein performing the correlation analysis comprises separating correlation analyses of agents based on at least one agent characteristic.

7. The method of claim 6, wherein the at least one agent characteristic comprises at least one of work experience or work tenure.

8. The method of claim 1, further comprising providing correlation test results of the correlation analysis via an application programming interface of the computing system.

9. The method of claim 8, wherein providing the correlation test results comprises providing a list of learning modules that improve a particular performance metric of agents.

10. The method of claim 8, wherein providing the correlation test results comprises providing a list of learning modules that would improve one or more of a particular agent's performance metrics.

11. The method of claim 8, wherein providing the correlation test results comprises providing a list of agents recommended to participate in a particular learning module.

12. The method of claim 1, wherein the first set of performance metrics comprises at least two performance metrics selected from a call duration, a number of calls held, a number of calls transferred, a number of calls in which a second agent was consulted, a number of calls that were transferred as part of a consult, an amount of time spent in after call work, and an amount of time spent interacting.

13. A system for automated analysis of learning content's impact on agent performance, the system comprising:
at least one processor; and
at least one memory comprising a plurality of instructions stored thereon that, in response to execution by the at least one processor, causes the system to:
automatically determine a first set of performance metrics for an agent for a predefined first period before the agent participated in a learning module in response to notification of completion in the learning module;
automatically determine a second set of performance metrics for the agent for a predefined second period after the agent participated in the learning module in response to a determination that the predefined second period has elapsed;
compute a first set of performance metric differences between the first set of performance metrics and the second set of performance metrics; and
perform correlation analysis to determine whether the learning module has a significant effect on one or more performance metrics of the agent based on a plurality of performance metric differences computed for a plurality of agents, wherein the plurality of performance metric differences includes the first set of performance metric differences.

14. The system of claim 13, wherein to automatically determine the first set of performance metrics for the agent comprises to determine an agent identifier associated with the agent and a module identifier associated with the learning module; and
wherein the plurality of instructions further causes the system to automatically determine agent profile information associated with the agent.

15. The system of claim 13, wherein the plurality of instructions further causes the system to perform a periodic analysis of a potential lapsing of post-learning periods for each agent that has completed a learning module; and
wherein the determination that the predefined second period has elapsed is based on an execution of the periodic analysis.

16. The system of claim 13, wherein to perform the correlation analysis comprises to:
execute a goodness of fit test to confirm that the performance metric differences constitute a normal distribution; and
execute at least one of a paired t-test or a signed rank test to obtain a p-value and 95% confidence interval associated with the performance metric differences.

17. The system of claim 13, wherein to perform the correlation analysis comprises perform separate correlation analyses of agents based on at least one of work experience or work tenure.

18. The system of claim 13, wherein the plurality of instructions further causes the system to provide correlation test results of the correlation analysis via an application programming interface of the system; and
wherein to provide the correlation test results comprises to provide a list of learning modules that improve a particular performance metric of agents.

19. The system of claim 13, wherein the plurality of instructions further causes the system to provide correlation test results of the correlation analysis via an application programming interface of the system; and
wherein to provide the correlation test results comprises to provide a list of learning modules that would improve one or more of a particular agent's performance metrics.

20. The system of claim 13, wherein the plurality of instructions further causes the system to provide correlation test results of the correlation analysis via an application programming interface of the system; and
wherein to provide the correlation test results comprises to provide a list of agents recommended to participate in a particular learning module.

21. The system of claim 13, wherein the first set of performance metrics comprises at least two performance metrics selected from a call duration, a number of calls held, a number of calls transferred, a number of calls in which a second agent was consulted, a number of calls that were transferred as part of a consult, an amount of time spent in after call work, and an amount of time spent interacting.

22. A method of automated analysis of learning content's impact on agent performance, the method comprising:
triggering, by a computing system, a plurality of completion events associated with corresponding completion of a learning module by a plurality of agents;
automatically determining, by the computing system, a first set of performance metrics for each agent of the plurality of agents for a corresponding predefined first period before each corresponding agent of the plurality of agents participated in the learning module in response to each agent's respective completion of the learning module;
automatically determining, by the computing system, a second set of performance metrics for each agent of the plurality of agents for a corresponding predefined second period after each corresponding agent of the plurality of agents participated in the learning module in response to a determination that the corresponding predefined second period has elapsed;
computing, by the computing system, a set of performance metric differences between the first set of performance metrics and the second set of performance metrics; and
performing, by the computing system, correlation analysis to determine whether the learning module has a significant effect on one or more performance metrics of the plurality of agents based on the set of performance metric differences.
